(19) United States
(12) Patent Application Publication
(10) Pub. No.: US 2008/0046533 A1
(43) Pub. Date: Feb. 21, 2008

(54) DATA PROCESSING PROGRAM RECORDING MEDIUM, DATA SIGNAL, DATA PROCESSING DEVICE AND DATA PROCESSING METHOD

(75) Inventor: Takeshi Yamashita, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/690,955

(22) Filed: Mar. 26, 2007

(30) Foreign Application Priority Data
Aug. 16, 2006 (JP) 2006221782

(51) Int. Cl. G06F 15/16

(52) U.S. Cl. 709/207

(57) ABSTRACT

When a process is carried out relative to data and an error occurs in the process, information containing a URL to be designated to thereby access a Web page to thereby instruct re-execution of the predetermined process relative to the data is transmitted to the user having instructed execution of the process relative to the data.

### CROSS-REFERENCE TO RELATED APPLICATIONS

This application is based on and claims priority under 35 USC 119 from Japanese Patent Application No. 2006-221782 filed on Aug. 16, 2006.

### BACKGROUND

### Technical Field

The present invention relates to a data processing program recording medium, data signal, a data processing device, and a data processing method.

### SUMMARY

According to one aspect of the invention, there is provided a computer readable medium storing a program causing a computer to execute a data process, the process comprising executing a process relative to data and transmitting, when an error occurs during execution of the process relative to the data, information identifying the location of a Web page for instructing, by accessing thereto, re-execution of the process relative to the data, to a user having requested execution of the process relative to the data.

### BRIEF DESCRIPTION OF THE DRAWINGS

An exemplary embodiment of the present invention will be described in detail on the following figures, wherein:

FIG. 1 is a diagram showing an overall structure of a data processing system in an exemplary embodiment;

FIG. 2 is a block diagram showing a structure of a data processing device in the exemplary embodiment;

FIG. 3 is a diagram showing an example of registration in a job management database in the exemplary embodiment;

FIG. 4 is a flowchart of an error handling process carried out in the exemplary embodiment;

FIG. 5 is a diagram showing an example of content of an e-mail in the exemplary embodiment; and

FIG. 6 is a diagram showing an example of content of an e-mail in the exemplary embodiment.

### DETAILED DESCRIPTION

### Device Structure

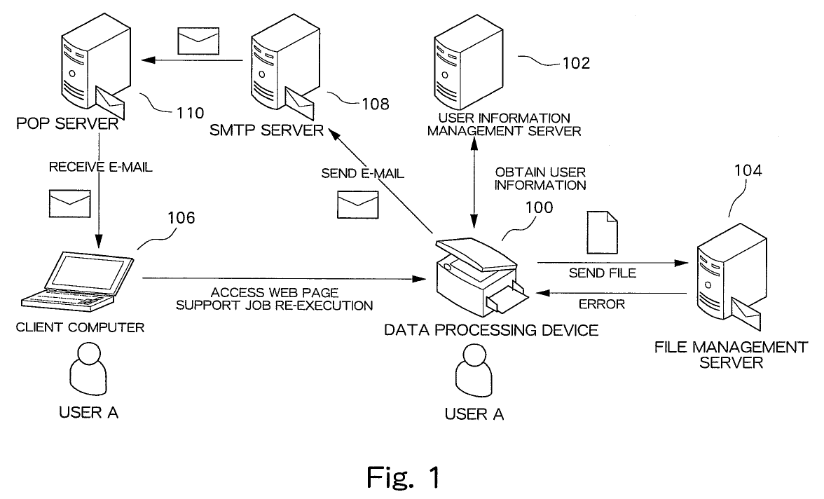

As shown in FIG. 1, a data processing system according to an exemplary embodiment of the present invention is constructed comprising a data processing device 100, a user information management server 102, a file management server 104, a client computer 106, an SMTP server 108, and a POP server 110. These devices are mutually connected for exchanging information via a communication network such as the Internet.

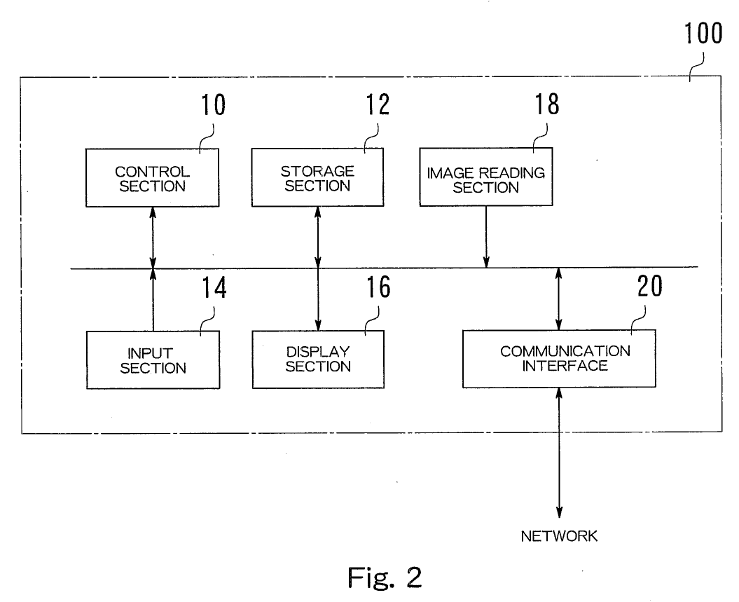

As shown in FIG. 2, the data processing device 100 is constructed comprising a control section 10, a storage section 12, an input section 14, a display section 16, an image reading section 18, and a communication interface 20. For information management, the data processing device 100 reads image information printed on a print medium, such as paper or the like, and sends the information to the file management server 104 according to a user's instructions.

The control section 10 is constructed comprising a CPU. The control section 10 executes a data processing program stored in the storage section 12 to integrally control the data processing carried out by the data processing device 100. The storage section 12 is constructed comprising a semiconductor memory. The storage section 12 stores a data processing program, and also temporarily stores information, such as image data scanned by the image reading section 18, or the like, to be processed by the data processing device 100. The storage section 12 may comprise a hard disk device, an optical disc device, a magnetic disk device, and so forth, in addition to, or instead of, the semiconductor memory.

The input section 14 is constructed comprising a keyboard, a pointing device, or the like. The input section 14 receives user instructions for reading of an image, transmission of image data, and so forth. The display section 16 is constructed comprising a liquid crystal panel or the like. The display section 16 presents to the user information (a user interface screen, and so forth) concerning a process carried out by the data processing device 100. It should be noted that an integrated device, such as a touch panel, comprising the input section 14 and the display section 16 may often be employed. The image reading section 18 is constructed comprising an optical scanner. The image reading section 18 optically reads a draft placed on a platen, or the like, using a photoelectric conversion element array, or the like, to produce digitalized image data, and outputs to the control section 10. According to a protocol such as TCP/IP or the like, the communication interface 20 exchanges an e-mail message and/or image data with other devices via a network (communication means).

The user information management server 102, the file management server 104, the client computer 106, the SMTP server 108, and the POP server 110 are each formed using a typical computer, and comprising a control section, a storage section, an input/output section, a communication interface, and so forth.

The user information management server 102 stores and holds, in the storage section, user information input by the user via the data processing device 100 or input in advance by the user via the input/output section, and transmits to the data processing device 100 in response to a request from the data processing device 100. The user information may contain a user ID, name, and e-mail address, and is registered as a user management database in such a manner that these elements are mutually associated.

The file management server 104 receives information (an electronic file or the like) which the data processing device 100 sends using the communication interface, and registers the received information for management in the file management database. Specifically, the file management server 104 stores, and thereby manages, electronic data having been sent according to a predetermined communication protocol, such as HTTP (Hyper Text Transfer Protocol), SOAP (Simple Object Access Protocol), and so forth, as a database in the storage section.

The client computer 106 executes a mailer program to thereby receive an e-mail message from the POP server 110, and presents the content of the e-mail to the user. The client computer 106 also executes a Web browser program to thereby access the data processing device 100, and instructs re-execution of the job, or the like, by the data processing device 100.

The SMTP server 108 sends an e-mail according to the SMTP protocol (Simple Mail Transfer Protocol). Upon receipt of an e-mail addressed to the user A from the data processing device 100, the SMTP server 108 forwards the e-mail to the POP server 110. It should be noted that although the SMTP protocol is used in this example, this is not an exclusive example, and any other suitable protocol may be used.

The POP server 110 receives an e-mail according to the POP3 protocol (Post Office Protocol version 3), or the like. The user A receives the e-mail from the POP server 110, using the client computer 106. Although the POP protocol is used in this example, this is not an exclusive example, and other protocols such as IMAP4 or the like, may be usable.

It should further be noted that, although the system is constructed using the data processing device 100, the user information management server 102, the file management server 104, the client computer 106, the SMTP server 108, and the POP server 110, which are all separate devices, two or more of these elements may be combined to be realized using a single computer.

### Processing Method

An example data processing method employed in the exemplary embodiment of the present invention will be described. Here, data is processed by executing processing programs by the data processing device 100, the user information management server 102, the file management server 104, the client computer 106, the SMTP server 108, and the POP server 110, respectively. That is, the respective devices carry out processing programs to thereby each function as a means corresponding to the process at each step.

A process to be carried out by the data processing device 100 is designated. Specifically, the user designates a process to be carried out by the data processing device 100, using the input section 14. In the above, the user ID is simultaneously input. The control section 10 stores information to be processed, data describing the content of the designated process, status information of the process, and a user ID as a job management database in the storage section 12 in the manner such that all elements are associated with a job ID.

In this exemplary embodiment, a process for reading image data from a draft using image reading section 18 and sending data to the file management server 104 will be described.

Specifically, upon receipt of a user instruction concerning a process, the control section 10 outputs an instruction requesting the image reading section 18 to begin scanning the draft. Upon receipt of the instruction for the scanning, the image reading section 18 optically scans the draft placed on the platen to thereby produce image data based on the image of the draft, using the photoelectric conversion element array. The produced image data is sent to the control section 10. The control section 10 temporarily stores the image data in the storage section 12, and produces a job.

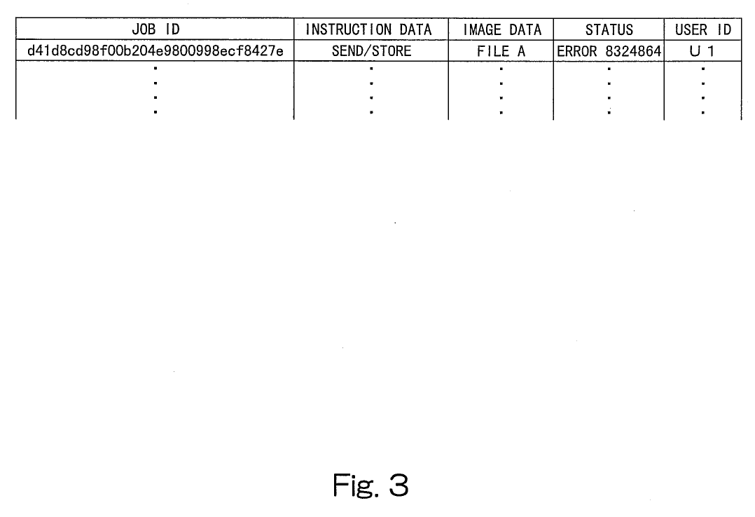

As shown in FIG. 3, the job is managed by mutually associating image data (information) produced by scanning, instruction data for instructing transmission of the image data to the file management server 104, status information on the process, and a user ID. Each job is assigned with a unique job ID, and managed by utilizing the assigned job ID. A job ID may be produced using a hash function, MD5, SHA-1, or the like, to make it difficult for an outside party to guess a job ID, or a random number may be used instead of the product of a hash function. Each job is registered as a job management database in the storage section 12 so as to be specifiable by the job ID.

The control section 10 of the data processing device 100 produces a job, as described above, and sends the scanned image data sent from the image reading section 18 to the file management server 104.

Here, the data processing device 100 can detect an error occurring in data transferring. Specifically, when data is transferred according to the HTTP, an error can be identified with reference to an HTTP status code received. When data is transferred according to SOAP, an error can be identified with reference to an SOAP fault (SOAP Fault) received.

For example, errors can be classified into two types: (1) undelivered data to the file management server 104, and (2) a program processing error caused in the file management server 104. Examples of Type (1) errors may include (1-a) lack of a physically connected communication section, and (1-b) a failure of a communication section, such as a router, or the like. Examples of Type (2) errors may include (2-a) over-capacity of the repository in the file management server 104 and (2-b) unsuccessful authentication of the user license.

When an error occurs in the file management server 104, the control section of the file management server 104 assigns a desired error code to the error, produces a Web page containing detailed information on the error content, and stores in the storage section. Thereafter, the control section of the file management server 104 sends information on the error content, for example, an error message containing an error code and the detailed information, to the data processing device 100 having requested the data processing.

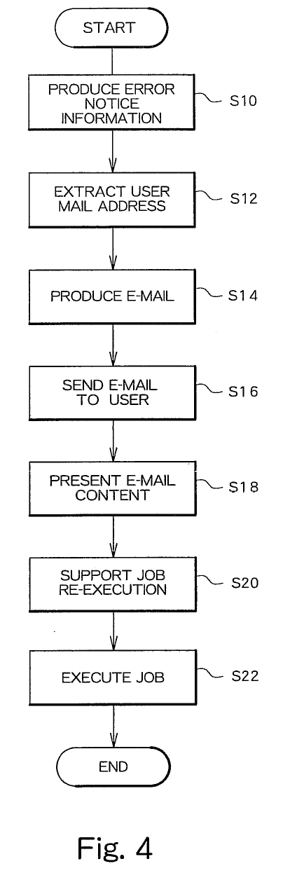

An error handling process in this exemplary embodiment begins upon detection of an error, following the flowchart of FIG. 4. Specifically, an error handling process is realized by executing a processing program by the data processing device 100, the user information management server 102, the file management server 104, the client computer 106, the SMTP server 108, and the POP server 110. That is, each of the devices carries out a processing program to thereby function as a means corresponding to the process at each step of the flowchart of FIG. 4.

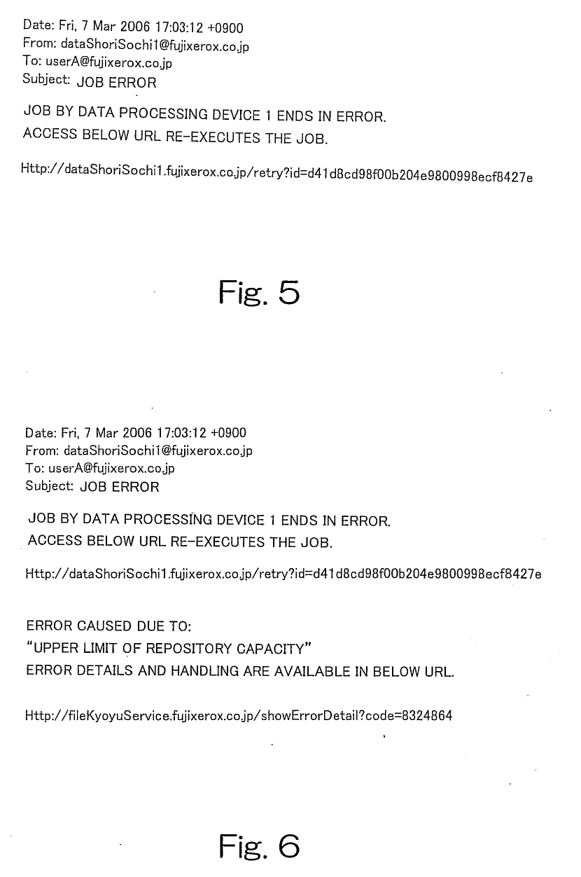

At step S10, the data processing device 100 produces error notice information. Specifically, when the error is one of Type (1), the control section 10 produces error notice information which contains detailed information on the cause of the error and the URL of a Web page for instructing re-execution of the job corresponding to the error, as shown in FIG. 5. The job for re-execution can be specified by producing a URL which contains the job ID of the job corresponding to the error.

Meanwhile, when the error is an error of Type (2), the control section 10 produces error notice information which contains an error message sent from the file management server 104, the URL of a Web page describing the detailed information of the error content, and the URL of a Web page for instructing re-execution of the job corresponding to the error, as shown in FIG. 6.

At step S12, the mail address of the user is obtained, using the user ID of the user who instructed the job for which an error occurred. Specifically, the control section 10 sends the user ID of the user having instructed the job with an error occurred to the user information management server 102. The user information management server 102, with reference to the user management database stored in the storage section, extracts the name and mail address of the user associated with the user ID received, and returns the information to the data processing device 100. The control section 10 of the data processing device 100 receives the information.

At step S14, an e-mail message which contains error notice information is produced. Specifically, the control section 10 produces an e-mail which contains the error notice information produced at step S10 and accompanied by the network address of the data processing device 100.

At step S16, the e-mail is sent to the client computer 106. Specifically, the control section 10 dispatches the e-mail produced at step S14 to the network via the communication interface 20. The e-mail is then delivered via the SMTP server 108 and the POP server 110 to the client computer 106. The client computer 106 receives the e-mail via the communication interface. As in this example these process steps are performed according to the general TCP/IP protocol, detailed description of these steps is not included here.

At step S18, the content of the e-mail is presented to the user. Specifically, in the client computer 106, the error notice information contained in the e-mail received at step S18 is displayed on the display device. Therefore, the user who instructed the job can be made aware that an error occurred during execution of the job. The user can also understand the nature or content of the error by referring to the detailed information of the error.

As for an error of Type (2), the error notice information contains the URL of a Web page which describes detailed information of the error content, as shown in FIG. 6. Therefore, the user can use a Web browser to access that URL, download the Web page stored in the storage section of the file management server 104, and review the detailed information on the error. The user can then remove the error caused in the file management server 104 while reviewing the Web page, and proceed to the subsequent processes.

At step S20, re-execution of the job is instructed. Specifically, the user, after reviewing the error content and determining the need of re-execution of the job, designates the URL of a Web page, using the Web browser, to instruct re-execution of the job corresponding to the error. Consequently, the URL containing the job ID is sent to the data processing device 100, whereby re-execution of the job is instructed.

At step S22, the job is executed again. Specifically, the client computer 106 accesses the control section 10 of the data processing device 100, and the job ID contained in the URL is extracted. Also, presence or absence of a job ID in the job management database stored in the storage section 12, which matches the extracted job ID, is determined. When there is a matching job ID registered, the image data (information) registered in the manner of being associated with that job ID and an instruction concerning the content of the process are extracted. Then, the control section 10 executes the job again according to the extracted image data (information) and the instruction concerning the process content.

As described above, an arrangement for instructing re-execution of the job using a URL makes it possible to instruct re-examination of a job, using a Web browser which may be commonly available in a general client computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a data process, the process comprising:
executing a process relative to data; and
transmitting, when an error occurs during execution of the process relative to the data, information identifying the location of a Web page for instructing, by accessing thereto, re-execution of the process relative to the data, to a user having requested execution of the process relative to the data.

2. The recording medium according to claim 1, wherein, in the transmission of the information, information describing content of the error is transmitted together with the information identifying the location of the Web page to the user having requested execution of the process relative to the data.

3. The recording medium according to claim 1, wherein, in the transmission of the information, information describing a method for handling the error is transmitted together with the information identifying the location of the Web page to the user having requested execution of the process relative to the data.

4. The recording medium according to claim 1, wherein, in the execution of the process relative to the data, the data is transmitted to an external device via a communication section.

5. The recording medium according to claim 1, wherein, in the transmission of the information, an e-mail describing a URL of the Web Page is transmitted.

6. The recording medium according to claim 4, wherein the executed process further comprises:
receiving information concerning the error from the external device when the error concerns reception of the data by the external device,
wherein
in transmission of the information, the information concerning the error is transmitted together with the information identifying the location of the Web page to the user having requested execution of the process relative to the data.

7. The recording medium according to claim 6, wherein, the error is caused by capacity shortage of a storage section in the external device.

8. The recording medium according to claim 6, wherein, the error is caused by an unsuccessful authentication of a user having instructed execution of the process relative to the data in the external device.

9. The recording medium according to claim 6, wherein, the error is caused by discrepancy of the data subjected to the process in the external device.

10. A computer data signal embodied in a carrier wave for enabling a computer to perform a data process, the process comprising:
executing a process relative to data; and
transmitting when an error occurs during execution of the process relative to the data, information identifying the location of a Web page for instructing, by accessing thereto, re-execution of the process relative to the data, to a user having requested execution of the process relative to the data.

11. The computer data signal according to claim 10, wherein, in the transmission of the information, information describing content of the error is transmitted together with the information identifying the location of the Web page to the user having requested execution of the process relative to the data.

12. The computer data signal according to claim 10, wherein, in the transmission of the information, information describing a method for handling the error is transmitted together with the information identifying the location of the Web page to the user having requested execution of the process relative to the data.

13. A data processing device, comprising:
a data process unit that executes a process relative to data; and
an information transmission unit that transmits, when an error occurs during execution of the process relative to the data, information identifying the location of a Web page for instructing, by accessing thereto, re-execution of the process relative to the data, to a user having requested the data process unit to execute the process relative to the data.

14. The data processing device according to claim 13, wherein the information transmission unit transmits information describing content of the error together with the information identifying the location of the Web page to the user having requested the data process unit to execute the process relative to the data.

15. The data processing device according to claim 13, wherein the information transmission units transmits information describing a method for handling the error together with the information identifying the location of the Web page to the user having requested the data process unit to execute the process relative to the data.

16. A data processing method comprising:
executing a process relative to data; and
transmitting, when an error occurs during execution of the process relative to the data, information identifying the location of a Web page for instructing, by accessing thereto, re-execution of the process executed by a data process unit relative to the data, to a user having requested the data process unit to execute the process relative to the data.

17. The data processing method according to claim 16, wherein, in the transmission of the information, information describing content of the error is transmitted together with the information identifying the location of the Web page to the user having requested execution of the process relative to the data.

18. The data processing method according to claim 16, wherein, in the transmission of the information, information describing a method for handling the error is transmitted together with the information identifying the location of the Web page to the user having requested execution of the process relative to the data.
